(19) United States
(12) Patent Application Publication
(10) Pub. No.: US 2025/0200704 A1
(43) Pub. Date: Jun. 19, 2025

(54) Method for Applying a Method for Increasing a Resolution of an Image of a Thermal Imaging Camera

(71) Applicant: Robert Bosch GmbH, Stuttgart (DE)

(72) Inventors: Nicole Ventsch, Stuttgart (DE); Andreas Frischen, Leonberg (DE); Axel Rumberg, Karlsruhe (DE); Ina Sophie Boettcher, Simmersfeld (DE); Michael Frank, Bretten (DE); Patrick Meyer, Leinfelden-Echterdingen (DE)

(21) Appl. No.: 18/978,385

(22) Filed: Dec. 12, 2024

(30) Foreign Application Priority Data
Dec. 14, 2023 (DE) 10 2023 212 660.5

(51) Int. Cl. G06T 3/4053; H04N 23/11

(52) U.S. Cl. CPC G06T 3/4053; H04N 23/11

(57) ABSTRACT

A process for applying a method for increasing a resolution of an image of a thermal imaging camera includes (i) providing image data, wherein the image data comprises a defined number of images, wherein the images are regular camera images and/or thermal images, and wherein the image data is captured by the thermal imaging camera, (ii) analyzing a contrast in the image data, and (iii) initiating the application of the method for increasing the resolution as a function of a result of the analysis of the contrast in the image data. A computer program, a device, and a storage medium for this purpose is also disclosed.

This application claims priority under 35 U.S.C. § 119 to patent application no. DE 10 2023 212 660.5, filed on Dec. 14, 2023 in Germany, the disclosure of which is incorporated herein by reference in its entirety.

The disclosure relates to a method for applying a method for increasing a resolution of an image of a thermal imaging camera. The disclosure further relates to a computer program, a device, and a storage medium for this purpose.

### BACKGROUND

A main argument impacting the decision to purchase a thermal imaging camera is the resolution of the thermal image. The higher the resolution, the more details can be seen and the more use cases can be handled with the camera. The resolution is thus an important feature of high-quality thermal imaging cameras. However, since resolution depends directly on the quality and thus the price of the infrared sensors used, a higher sensor resolution automatically also means a higher price for the components. Alternatively, algorithms may be used to improve image quality as a way to improve resolution without more expensive components. For example, super-resolution algorithms are used to improve the resolution, i.e. in particular increasing a number of pixels. Both classic algorithms, meaning algorithms based on classical image processing, and algorithms based on machine learning can be used for this purpose.

During a real-time use of a thermal imaging camera, insufficient conditions, such as insufficient contrast for a method for increasing a resolution of an image of a thermal imaging camera, in particular a super-resolution algorithm, may result in the degradation of the processed images compared to the original images.

### SUMMARY

The subject-matter of the disclosure is a method having the features of claim 1, a computer program having the features of claim 11, a device having the features of claim 12, and a computer-readable storage medium having the features of claim 13. Further features and details of the disclosure will emerge from the respective dependent claims, the description, and the drawings. Features and details which are described in connection with the method according to the disclosure naturally also apply in connection with the computer program according to the disclosure, the device according to the disclosure, and the computer-readable storage medium according to the disclosure, and vice versa in each case, so that reference is always or can always be made to the individual aspects of the disclosure with respect to the disclosure.

The subject matter of the disclosure is in particular a procedure for using a method for increasing a resolution of an image of a thermal imaging camera comprising the following steps, wherein the steps can be carried out repeatedly and/or sequentially. Increasing the resolution is in particular a technical process in which the number of pixels in the image of the thermal imaging camera is increased in order to improve a detail and sharpness of the image perceived by a user. This may be accomplished in a variety of ways, for example by interpolation, wherein new pixels are inserted between the existing pixels of the image. Further, super-resolution algorithms may be employed, which are a specialized form of image resolution enhancement. In particular, missing details are reconstructed in low-resolution images in such enhancements. Super-resolution algorithms can often provide more detailed and clear results than simple interpolation. The thermal imaging camera is preferably a handheld thermal imaging camera, i.e. a thermal imaging camera, which can be held and operated by a user.

In a first step, preferably image data is provided, wherein the image data consists of a defined number of images, wherein the images are regular camera images and/or thermal images, wherein the image data is captured by the thermal imaging camera. The regular camera images may also be understood and referred to as visual images in the context of the present disclosure, and are in particular images representing a spectrum of light visible to a human. The regular camera images may be captured by a camera sensor of the thermal imaging camera. The thermal images are in particular infrared images, i.e. images in a spectrum of the infrared range. The thermal images may be captured using an infrared camera sensor of the thermal imaging camera.

In a further step, a contrast in the image data is preferably analyzed. For example, a histogram analysis may be performed to determine the contrast based on a certain percentage of a pixel intensity or brightness distribution. Another possible approach could be to calculate the standard deviation of pixel intensities or brightness values in order to be able to determine and analyze the contrast. Further, a local contrast analysis may be performed. In such an analysis, the contrast in different areas of the image is analyzed separately.

In a further step, preferably the application of the method for increasing the resolution is initiated depending on a result of the analysis of contrast in the image data. In particular, this expresses that the method for increasing the resolution is thus only applied, for example, when sufficient contrast is determined in the image data. Various methods known in the prior art, for example an interpolation or a super-resolution, can be carried out as methods for increasing resolution. It is possible that the method for increasing the resolution may provide worse results if there is a low contrast in the image data. The present method can thus advantageously evaluate whether the image data is suitable for the method for increasing the resolution based on the evaluation parameter of contrast.

Preferably, the disclosure may further provide that the analysis comprises the following steps:
defining a threshold for contrast in the image data,
comparing the respective contrasts of individual images of the image data with the defined threshold for contrast.

The threshold for the can be defined in a variety of ways depending on a specific use case and desired criteria. For example, a histogram analysis may be performed. In such an analysis, the threshold may be defined based on a certain percentage of a pixel intensity or brightness distribution. Another possible approach could be a calculation of the standard deviation of pixel intensities or brightness values. The threshold could then be defined as, for example, a multiple of the standard deviation to identify regions of high contrast. Further, a local contrast analysis may be performed. In particular, during this analysis the contrast in different regions of the image is analyzed separately and a local threshold value is determined. This may be advantageous in images with varying illumination conditions. Preferably, the contrast of the individual images is determined in an analogous manner as when defining the threshold for the contrast in order to perform the comparison.

If the comparison shows that the contrast of a defined number of images is above the defined threshold, it may be provided that only images of the defined number of images with a contrast above the defined threshold are provided in the course of the initiation. In other words, the method for increasing the resolution can only be carried out with images with a contrast suitable for the method for increasing the resolution, whereby a result of the method can advantageously be improved.

It is further contemplated that if the result of the comparison shows that the contrast of a defined number of images is below the defined threshold, the initiation will be blocked. It is possible that the method for increasing the resolution only provides a satisfactory result above a certain contrast value and could otherwise even cause degradation. Therefore, the method according to the present disclosure may advantageously prevent the application of the method for increasing the resolution if the contrast is below the defined threshold. If the initiation of the application of the method to increase the resolution is blocked, it may be provided that a corresponding output will be transmitted to a user of the thermal imaging camera, for example via a display or speaker of the thermal imaging camera. The output could indicate to the user that the method to increase the resolution, which may be implemented by a particular mode in the thermal imaging camera, for example, is currently not available.

Preferably, it may be contemplated within the scope of the disclosure that that the method for increasing the resolution comprises the following steps, wherein the steps are preferably carried out one after the other. In a first step, preferably a subpixel shift of the defined number of images is determined compared to a reference image, wherein the reference image is one of the defined number of images. In this step, in particular for each image of the defined number of images, a shift on the subpixel level relative to the selected reference image is determined, for example via a determination of an optical flow. For example, the selected reference image may be the image of the defined number of images which was taken last. This shift is in particular necessary to compensate for differences in the camera position or perspective between the images. Accuracy at the subpixel level advantageously allows for more precise alignment, which can increase the quality of the resulting image.

In a further step, preferably the defined number of images is shifted based on the determined subpixel shift so as to be aligned with the reference image. After the subpixel shift has been determined for each image of the defined number of images, the images can be shifted accordingly to align them with the reference image. This alignment can advantageously ensure that corresponding points match in all images, which is in particular necessary for a subsequent fusion of the images.

In a further step, the defined number of images are preferably scaled by a defined scaling factor. For example, a four-fold scaling, i.e. a defined scaling factor of four, may be provided. This may be done for various reasons, such as adjusting the images to a particular target resolution or standardizing the image sizes to improve alignment and/or reduce computational load during subsequent image fusion. As part of the scaling, each of the images of the defined number of images may be interpolated.

In a further step, preferably a resulting image is determined based on the scaled defined number of images and the determined subpixel shift. This step may also be understood as a fusion of the images to the resulting image. In the last step in particular, therefore, the final high-resolution image is generated by combining the previously scaled and aligned images with one another. Information from all images of the defined number of images is preferably integrated during this process, taking into account their respective subpixel shifts. This integration may advantageously lead to the creation of a more detailed and sharper image, which can significantly improve the resolution and quality compared the individual starting images.

The method for increasing resolution is preferably a super-resolution algorithm, in particular a multi-image super-resolution algorithm.

In addition, it may be advantageous in the context of the disclosure that the defined number of images are both regular camera images and thermal images. The regular camera images and the thermal images are preferably captured in parallel by the thermal imaging camera. Thus, the thermal imaging camera may comprise a camera sensor for capturing the regular camera images and a thermal imaging camera sensor, or infrared camera sensor, for capturing the thermal images. The parallel capturing may express that a respective pair of images is simultaneously captured, consisting of a regular camera image and a thermal image, wherein a time tolerance between the two captures may be accepted. A link between the regular camera image and the thermal image captured in parallel can thus be advantageously created.

Moreover, in the context of the disclosure, it is advantageous if the step of determining the subpixel shift is performed based on the regular camera images in order to perform the shifting, scaling and determining of the resulting image based on the thermal images and the subpixel shift determined based on the regular images. A higher resolution and/or a higher detectable level of detail may be present in the regular camera images, which may advantageously make a more precise determination of the subpixel shift possible.

Further, it is optionally contemplated that the step of determining the subpixel shift, shifting, scaling, and determining the resulting image be performed based on the thermal images. Thus, advantageously, the method for increasing the resolution can be carried out independent of the regular camera images. It can also be provided that the subpixel shift is determined based on both the regular camera images and the thermal images in order to be able to advantageously compare the respective determined subpixel shifts, for example to detect errors.

Furthermore, it is optionally possible in the context of the disclosure that the defined number of images are thermal images. The step of determining the subpixel shift, shifting, scaling, and determining the resulting image may then be performed based on the thermal images. Thus, advantageously the method for increasing the resolution may be performed independent of the regular camera images, i.e. with only a thermal imaging or infrared camera sensor.

Moreover, it is advantageous in the context of the disclosure if the defined number of images are both regular camera images and thermal images, wherein the regular camera images and the thermal images are captured in parallel by the thermal imaging camera. In this regard, please refer to the above statements in the analogous section. The steps of analyzing and initiating can first be performed based on the regular camera images. Thus, it is possible to first test whether application of the method for increasing the resolution with the regular camera images is possible or sensible. As part of the method for increasing the resolution, the subpixel shift could then be performed based on the regular camera images. The steps of analyzing and initiating may then be performed again based on the thermal images, depending on the result of the contrast analysis, if the result indicates that the contrast for the regular camera images is below a defined threshold. The method for increasing the resolution may thus also optionally be carried out exclusively based on the thermal images if the regular camera images have too little contrast.

The disclosure may provide that the method further comprises the following step:
initiating a display of the resulting thermal image.

The thermal imaging camera may comprise a display on which the resulting thermal image is displayed. A transfer of the resulting thermal image to a further data processing device on which the resulting thermal image is to be displayed is also contemplated.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a thermal imaging camera, a device, a storage medium, and a computer program according to exemplary embodiments of the disclosure,

FIG. 2 a schematic illustration of a method according to exemplary embodiments of the disclosure.

### DETAILED DESCRIPTION

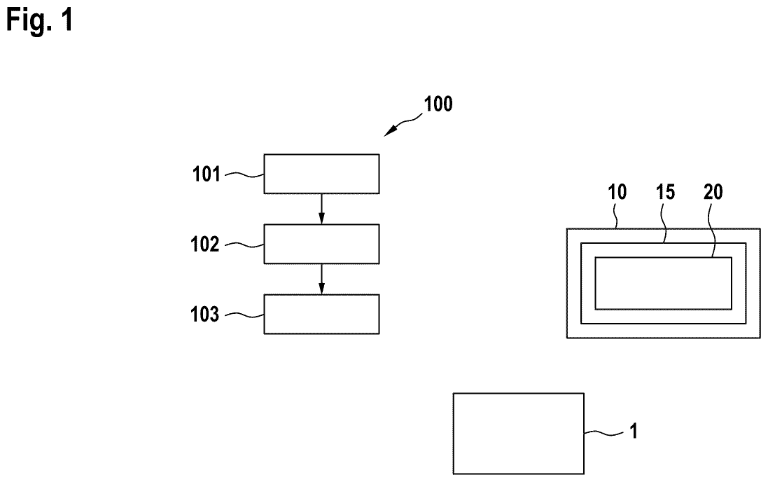

FIG. 1 schematically illustrates a method 100, a thermal imaging camera 1, a device 10, a storage medium 15, and a computer program 20 according to exemplary embodiments of the disclosure.

In particular, FIG. 1 shows an exemplary embodiment of a method 100 for applying a method to increase the resolution of an image of a thermal imaging camera 1. In a first step 101 image data is provided, wherein the image data consists of a defined number of images, wherein the images are regular camera images and/or thermal images, wherein the image data is captured by the thermal imaging camera 1. In a second step 102, a contrast in the image data is analyzed. In a third step 103, the application of the method for increasing the resolution depending on a result of the analysis of the contrast in the image data is initiated.

Super-resolution is a possible method for increasing the resolution of images that may be applied in thermal imaging cameras 1. One idea is that, preferably, several images are taken rapidly in a row and combined to form a higher resolution image. This is done in two steps, for example, wherein any number N of images can be taken into consideration. In a first step, for example, the N images are registered using their optical flow relative to a reference image to determine how they are shifted from each other. In a second step, the registered images are particularly fused to a new, higher-resolution image. The visual image can be used for determining the subpixel shifts, i.e. the optical flow, because it has a higher resolution and thus more accurate shifts can be determined. In the context of the present disclosure, a visual image is in particular an image that is captured by a regular camera and represents a light spectrum visible to a human. However, the fusion must be carried out in particular based on the thermal images, as they are to be improved.

The first step is thus carried out in particular via the determination of the optical flow and the second via iterative methods, for example using classical image processing methods. Alternatively, however, machine learning-based methods can also be used that solve these steps using machine learning models, in particular neural networks.

In the context of the disclosure, according to exemplary embodiments, whether the method for increasing the resolution of the thermal imaging camera 1, i.e. in particular the super-resolution algorithm, is to be applied, whether this is to be applied in an adjusted manner or whether it is to be deactivated or blocked if conditions are insufficient, is determined based on the contrast of the thermal images and/or the visual images.

One aspect of the present disclosure according to exemplary embodiments is thus in particular an application of the method for increasing the resolution of the thermal imaging camera 1, in particular of the super-resolution algorithm in thermal imaging camera 1, depending on the contrast of the images.

First, preferably a sequence of images is taken into consideration, for example three images. Subsequently, a shift of the images relative to each other may be determined in order to map the images to one other. Subsequently, the registered images are preferably fused into a single image with better resolution according to a method for increasing the resolution of the thermal imaging camera 1. An example of such an algorithm would be the Multi-Memory Convolutional Neural Network for Video Super-Resolution (MMCNN) algorithm, but other machine learning models such as neural networks having the same blocks, i.e. image registration followed by image fusion, may be used. Alternatively, the algorithm may also be created from two individual machine learning models, one for image registration and one for image fusion. The higher resolution visual images may be used for a more accurate image registration. The movement determined thereon may then be transferred to the thermal images required for the fusion, since their resolution is to be improved. The machine learning models used are preferably already trained so that they can be used without major changes and can at most be retrained to improve their performance.

However, the method for increasing the resolution of the thermal imaging camera 1, regardless of which method is specifically used, preferably requires certain conditions to be met in order to achieve a high-quality result and ensure the thermal image is not degraded. Thus, according to exemplary embodiments, the disclosure relates primarily to a conditional application of the method for increasing the resolution of the thermal imaging camera 1, in particular the super-resolution. Insufficient contrast in the images may result in the images not being accurately registered, such that the subpixel shift of the individual images to one other is miscalculated and the image resulting from the method is of worse quality than the original image. This may be the case in particular if only the visual image is used for the registration and no contrast is present in the visual image, although contrast is present in the thermal image. This can occur, for example, when capturing images at night or in the dark.

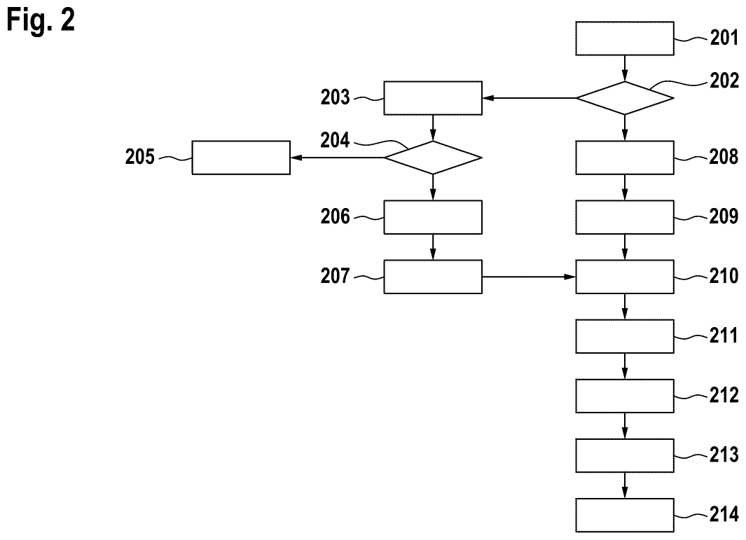

Therefore, the image registration should preferably be based on thermal images if they have sufficient contrast, but not the visual images, i.e. regular camera images, captured by a regular camera sensor. If neither have sufficient contrast, the method for increasing the resolution of the thermal imaging camera 1 should preferably not be applied at all. A possible process according to an exemplary embodiment is shown in FIG. 2. The process shown in FIG. 2 is preferably performed for new images for as long as the thermal imaging camera 1 is on, in particular permanently. To do so, a method for increasing the resolution of the thermal imaging camera 1 may be applied, which determines the image registration on the visual images. If the method uses thermal images, the first part may be skipped and the method may be started at step 203, according to which the contrast is determined in N consecutive thermal images. This part can also be covered on visual images in case of registration. According to step 201, the contrast in N consecutive visual images is preferably determined, and according to step 202, continuous testing is carried out to determine whether more than a set number (e.g., half) of these N (e.g., 5) successive visual images has a contrast above a defined threshold. If so, any visual images satisfying this condition may be used for image registration; the remaining images are preferably discarded according to step 208. The optical flow is determined in particular according to step 209 for the visual images used, in order to obtain a subpixel shift to a reference image (e.g., the latest image used). This subpixel shift is then preferably transferred to the thermal images according to step 210 and these are shifted according to step 211, in particular by whole pixels, so that the image content is superimposed as far as possible. Then, the thermal images are scaled according to step 212 to a multiple of the original size (e.g., four-fold) and fused according to step 213 taking into account the determined subpixel shift to obtain a resulting, highly scaled thermal image. This may then be displayed on a display of the thermal imaging camera 1 according to step 214. If at least half of the visual images taken into consideration do not have contrast above the defined threshold, preferably the visual images will not be used for registration of the method for increasing the resolution of the thermal imaging camera 1. In that case, a test is preferably carried out according to step 203 to determine whether the thermal images have sufficient contrast. If, for example, a contrast is below the defined threshold value in only at most half of the thermal images, then in particular no sufficiently accurate registration can be applied to these, so that no method for increasing the resolution of the thermal imaging camera 1, in particular no super-resolution, is applied. Then preferably according to step 205, the original image is displayed accordingly on the display of the thermal imaging camera 1. If more than half of the thermal images have a contrast over the defined threshold, the prerequisites for the application of the method for increasing the resolution of the thermal imaging camera 1, i.e. in particular the super-resolution, are met. In that case, the thermal images with too little contrast are preferably discarded in accordance with step 206, and the subpixel shift relative to the reference image may be determined from the remaining images using the optical flow in accordance with step 207.

Then, the thermal images are preferably first shifted according to step 211 by whole pixels corresponding to the previously determined optical flow and scaled up according to step 212 to a multiple of the original resolution. Finally, these highly scaled thermal images are fused according to step 213, in particular to a single, high-resolution image, and are displayed on the display of the thermal imaging camera 1 according to step 214.

As a possible use case according to an exemplary embodiment is a real-time application of the thermal imaging camera 1, this process is preferably carried out in a loop over the entire time the thermal imaging camera 1 is in use.

The method for increasing the resolution, i.e. in particular the super-resolution algorithm, can be used in both the real-time application on the thermal imaging camera 1 as well as when storing the images or in a computer/smartphone app for post-processing. In the case of post-processing, whether the contrast in visual and thermal images permits a method for increasing the resolution, in particular a super-resolution, to be used is preferably evaluated in the device and a corresponding quality indicator can be generated. After transmission of the images together with the quality indicator, the computer or smartphones can be used to assess whether the conditions for applying the method for increasing the resolution, in particular the super-resolution, are given and, if they are, the method for increasing the resolution, in particular the super-resolution algorithm, can be performed. In the case of a real-time application, all these steps can be performed on the device, i.e., in particular on the thermal imaging camera 1.

The above explanation of the embodiments describes the present disclosure solely within the scope of examples. Of course, individual features of the embodiments may be freely combined with one another, if technically feasible, without leaving the scope of the present disclosure.

What is claimed is:

1. A method for applying a method to increase a resolution of an image of a thermal imaging camera, comprising:
providing image data, wherein the image data comprises a defined number of images, wherein the images are regular camera images and/or thermal images, and wherein the image data is captured by the thermal imaging camera;
analyzing a contrast in the image data; and
initiating the application of the method for increasing the resolution as a function of a result of the analysis of the contrast in the image data.

2. The method according to claim 1, wherein the analyzing step comprises:
defining a threshold for contrast in the image data, and
comparing the respective contrasts of individual images of the image data with the defined threshold for contrast.

3. The method according to claim 2, wherein:
when the result of the comparison shows that the contrast of a set number of images is above the defined threshold, only images of the defined number of images with a contrast above the defined threshold are provided in the context of the initiation.

4. The method according to claim 2, wherein:
if the result of the comparison shows that the contrast of a defined number of images is below the defined threshold, the initiation is blocked.

5. The method according to claim 1, wherein the method for increasing the resolution of the image of the thermal imaging camera comprises:
determining a subpixel shift of the defined number of images compared to a reference image, wherein the reference image is one of the defined number of images,
shifting the defined number of images based on the determined subpixel shift to align with the reference image,
scaling the defined number of images by a defined scaling factor, and
determining a resulting image based on the scaled defined number of images and the determined subpixel shift.

6. The method according to claim 5, wherein:
the defined number of images are both regular camera images and thermal images, and
the regular camera images and/or the thermal images are captured in parallel by the thermal imaging camera.

7. The method according to claim 6, wherein:
the step of determining the subpixel shift is carried out based on the regular camera images to perform the shifting, scaling, and determining the resulting image based on the thermal images and the subpixel shift determined based on the regular images.

8. The method according to claim 6, wherein:
the step of determining the subpixel shift, shifting, scaling, and determining the resulting image are carried out based on the thermal images.

9. The method according to claim 5, wherein:
the defined number of images are thermal images, and
the steps of determining the subpixel shift, shifting, scaling, and determining the resulting image are carried out based on the thermal images.

10. The method according to claim 1, wherein:
the defined number of images are both regular camera images and thermal images, wherein the regular camera images and the thermal images are captured in parallel by the thermal imaging camera,
the steps of analyzing and initiating are first carried out based on the regular camera images, and
the steps of analyzing and initiating are carried out again based on the thermal images as a function of the result of the analysis of the contrast, if the result indicates that the contrast for the regular camera images is below a defined threshold.

11. A computer program comprising instructions for causing the computer to carry out the method according to claim 1 when the computer program is executed by a computer.

12. A device for data processing, configured to carry out the method according to claim 1.

13. A computer-readable storage medium, comprising instructions which, when executed by a computer, cause it to carry out the steps of the method according to claim 1.
